(19) United States
(12) Patent Application Publication
(10) Pub. No.: US 2019/0199387 A1
(43) Pub. Date: Jun. 27, 2019

(54) Protective Case For Mobile Device

(71) Applicant: i-Blason LLC, Alpharetta, GA (US)

(72) Inventor: Xiaoqing Yang, Alpharetta, GA (US)

(73) Assignee: i-Blason LLC

(21) Appl. No.: 15/853,386

(22) Filed: Dec. 22, 2017

(51) Int. Cl. H04B 1/3888; A45C 11/18

(52) U.S. Cl. CPC H04B 1/3888; A45C 2011/002; A45C 11/182

(57) ABSTRACT

A protective device for a mobile device is equipped with a sliding drawer for carrying bank or identification cards. The sliding drawer slides in and out of a space defined between a main body and a cover of the protective device. The sliding drawer has a front face connected to a tray, which has a recess. The tray also defines a through-hole and the bank card can be easily lifted out of the tray by pushing up the bank card through the through-hole.

### FIELD OF THE INVENTION

The present invention generally relates protection of mobile devices, more specifically, relates to protective device for mobile device.

### BACKGROUND OF THE INVENTION

Mobile communication devices are constantly evolving and providing more features. Because of variety of functions provided by a mobile phone, often the mobile phone becomes almost the only device carried by a person when the person is out hiking or running errands around the town. However, the person cannot take only the mobile phone because the mobile phone, as versatile as it is, cannot be used as an official identification document or enable a purchase in a store no equipped with modern electronic mobile payment methods. The person has to carry an identification card or a credit card in addition to the mobile phone.

Therefore, it is desirable for a way for a person to carry one single mobile device that includes all the necessary information.

### SUMMARY OF THE INVENTION

The present invention discloses a multi-function protective mobile phone case. In one embodiment, the invention is a protective device for a mobile device comprising a main body with a front side and a back side, a cover mounted on the back side, and a drawer removably inserted into a space defined between the back cover and the back side.

In an alternative embodiment, it is disclosed a device comprising a main body receiving a mobile device, and a sliding drawer removably sliding into the main body.

### BRIEF DESCRIPTION OF THE DRAWINGS

The present invention discloses a multi-function protective mobile phone case and can be understood in more detail by reading the subsequent detailed description in conjunction with the examples and references made to the accompanying drawings, wherein:

FIG. 1 shows a protective mobile phone case according to one embodiment of the invention;

FIG. 2 illustrates placement of a bank card into the protective mobile pone case according to one embodiment of the invention;

FIG. 3 illustrates the protective mobile phone case with the top opened according to one embodiment of the present invention;

FIG. 4 illustrates the sliding drawer in the protective mobile phone case according to one alternative embodiment of the invention; and

FIG. 5 illustrates the back side of the sliding drawer according to one embodiment of the invention.

### DETAILED DESCRIPTION OF THE PREFERRED EMBODIMENTS

Mobile phones are becoming more sophisticated and more expensive. Because of the costly replacement, it is common for a mobile phone user to enclosed the mobile phone in a protective case. The protective case guards against any accidental dropping of the mobile phone and consequent damage to the mobile phone.

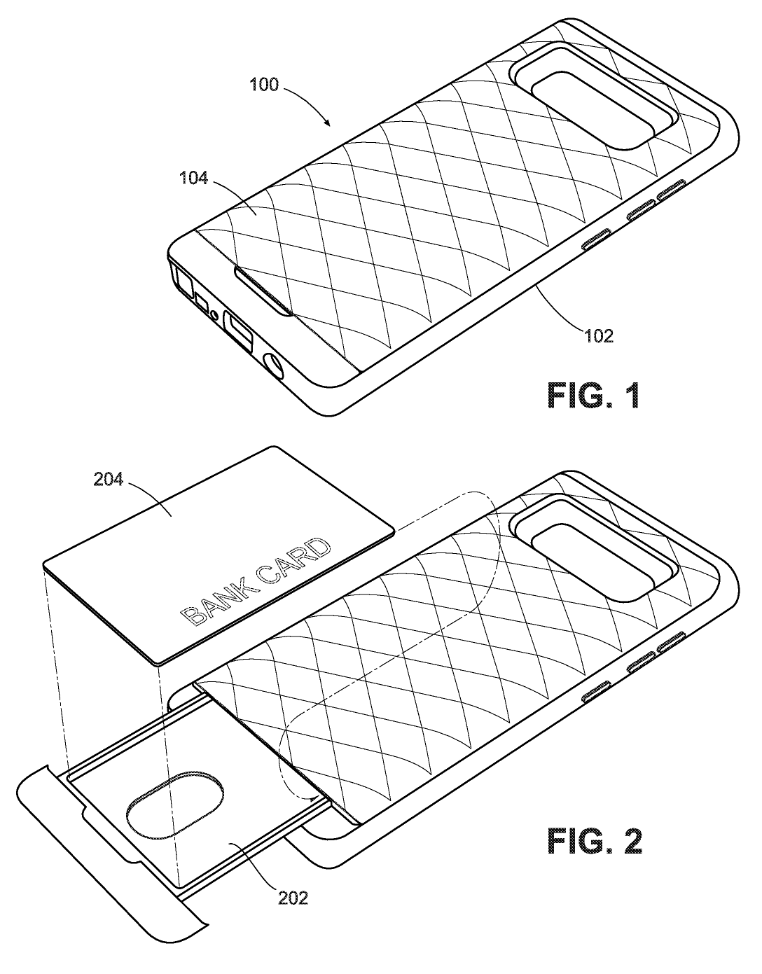

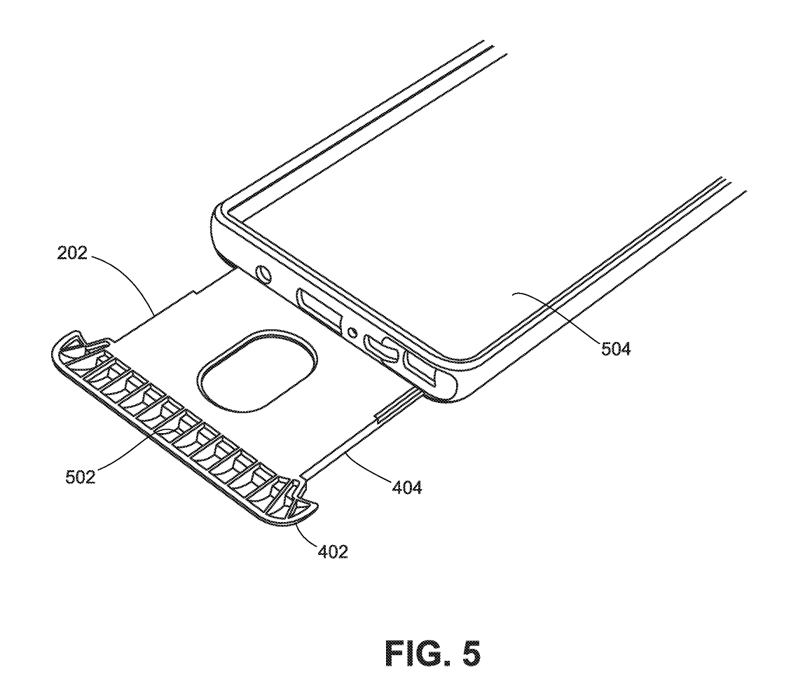

The present invention includes a multi-function protective case and can be understood in more detail by reading the subsequent detailed description in conjunction with the examples and references made to the accompanying drawings. FIG. 1 shows a protective mobile phone case 100 that comprises a main body 102 with a front side and a back side and a cover 104 covering the back side of the main body 102. The protective mobile phone case 100 is usually made from a combination of hard plastic and flexible rubber material that provides shock resistance and shock absorbing properties. A mobile phone is inserted into the main body 102 from the back side and the cover 104 is then placed on the back side of the main body 102 to enclose the mobile phone. The main body 102 usually has a clear front face 504 shown in FIG. 5. Alternatively, the main body 102 may have only a front opening that exposes the front face of the mobile. The cover 104 generally has one or more openings that expose the camera and the flash of the mobile phone.

Alternatively, the cover 104 and the main body 102 are one single piece and the mobile phone is inserted into the main body 102 through the front side.

The mobile phone case of the present invention has a compartment 202 capable of storing bank cards and/or identification card 204. FIG. 2 shows a sliding drawer 202 embedded in the cover 104 and the sliding drawer 202 slides into the cover 104. The sliding drawer 202 may have different sizes depending on the size of the mobile phone case and the sliding drawer 202 may slide in either longitudinal direction (as shown in FIG. 2) or transversal direction (not shown) of the mobile phone case.

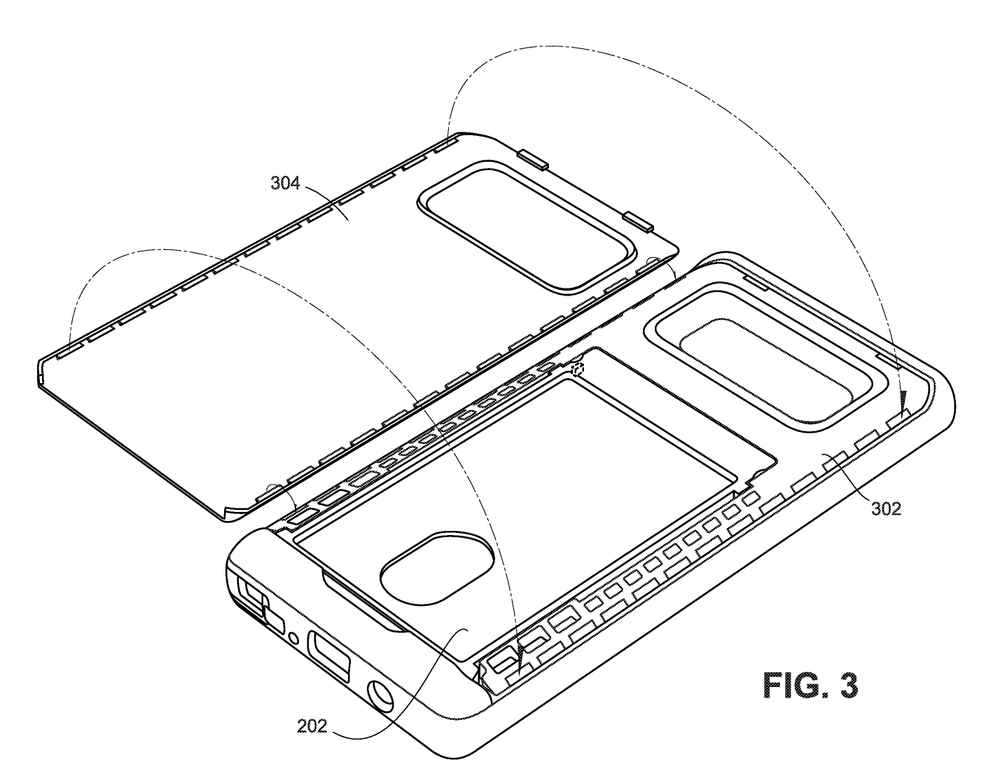

FIG. 3 illustrates one embodiment that shows assembly of the cover 104. The cover 104 comprises of a base 302 and a top 304 and the sliding drawer 202 is placed between the base 302 and the top 304. The base 302 engages the main body 102 of the mobile phone case. The sliding drawer 202 fits in a space between the base 302 and the top 304. The top 304 snaps onto the base 302 to form one single element.

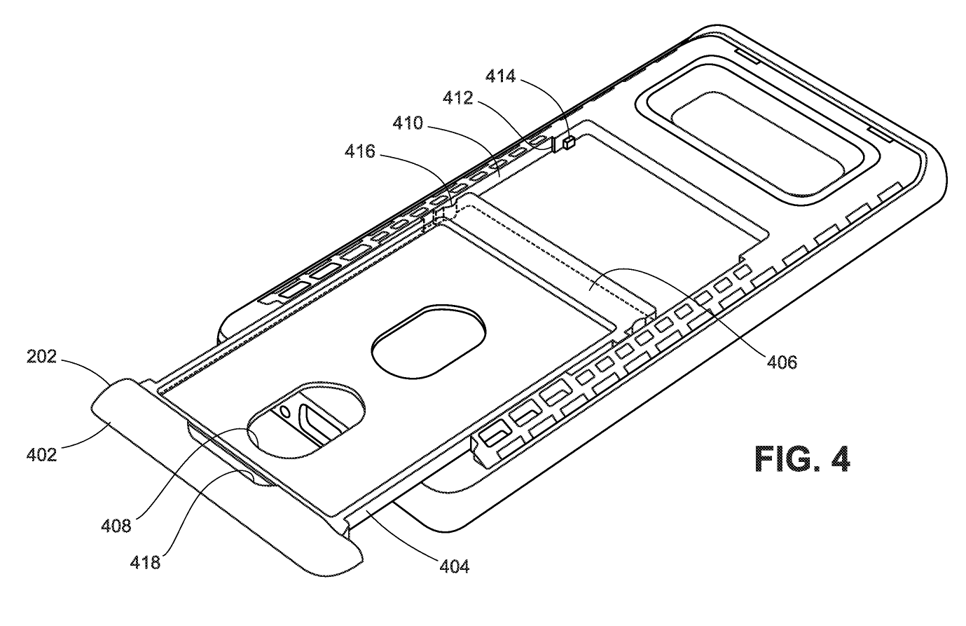

FIG. 4 illustrates one embodiment of the sliding drawer 202. The sliding drawer 202 comprises a front face 402 attached to a tray 404 with a back end 406. The tray 404 has a small recess of preferably 1 mm to 2 mm in height, enough for storing one or two bank cards. The tray 404 has a through-hole 408 for fitting a finger. Once a bank card is placed in the tray 404, the user can easily lift the bank card out of the tray 404 by inserting a finger through the through-hole 408 from under the tray 404.

The base 302 includes two sliding tracks 410, opposite of each other. The sliding draw 202 slides against these sliding tracks 410. Each sliding track ends at a stopper 412, so the tray 404 butts against the stoppers 412. The back end 406 has a width smaller than the width of the tray 404. The back end 406 has two recesses 416 disposed on the opposite sides of the back end 202. There are two latches 414, each latch 414 engages one recess 416. When the sliding drawer 202 is pushed in, the tray 404 slides along the sliding tracks 410 until the tray 404 rest against the stoppers 412 and the latches 414 engage the recess 416, thus preventing the sliding drawer 202 from sliding out. The front face 402 also has a finger recess 418 and the finger recess 418 enables a user to easily slides the sliding drawer 202 out.

FIG. 5 illustrates the back side of a sliding drawer 202. The front face 402 is attached to the tray 404 and the attachment is reinforced by a plurality of ribs 502 placed under the front face 402.

Though the invention is fully described in the embodiment above, the invention can be easily modified in different embodiments. For example, the storage of a bank card may be accessed through a flipping door on the cover 104. In another embodiment, the main body 102 and the cover 104 may be one single piece and the cover 104 may be covered by the top 304, under which the sliding drawer 202 slides.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures and different embodiments can be easily combined within the scope of the invention.

It will be apparent to a person skilled in the relevant art that features described in different embodiments described in the present specification may be combined. It is to be appreciated that the Detailed Description section, and not the Summary and Abstract sections, is intended to be used to interpret the claims. The Summary and Abstract sections may set forth one or more but not all exemplary embodiments of the present technology as contemplated by the inventor(s), and thus, are not intended to limit the present technology and the appended claims in any way.

1. A protective device for a mobile device comprising:
a main body with a front side and a back side;
a cover mounted on the back side of the main body; and
a drawer slidably inserted into a space defined between the cover and the back side of the main body,
wherein the main body at least one sliding track against which the drawer slides and the sliding track has a stopper and a latch.

2. The protective device of claim 1, wherein the drawer further comprises
a front face;
a tray connected to the front face; and
a back end connected to the tray,
wherein the tray has a first width and the back end has a second width, the second width is smaller than the first width.

3. The protective device of claim 2, wherein the back end further includes at least one recess.

4. The protective device of claim 2, wherein a recess is defined on the tray.

5. The protective device of claim 2, wherein the tray defines a through-opening, the tray receives a credit card and isolates the credit card from the mobile device.

6. The protective device of claim 2, wherein the front face further includes a finger recess.

7. The protective device of claim 2, wherein the front face has an underside with a plurality of reinforcement ribs, the plurality of reinforcement ribs are flashed with the underside.

8-9. (canceled)

10. The protective device of claim 1, wherein the latch engages at least one recess on the drawer.

11. The protective device of claim 1, wherein the drawer further defines a through-opening.

12. The protective device of claim 1, wherein the cover has an opening.

13. A device comprising:
a main body receiving a mobile device;
at least one sliding track attached to the main body;
at least one stopper attached to the at least one sliding track;
at least one latch attached to the at least one sliding track; and
a sliding drawer sliding on the at least one sliding track and engaging the at least one latch.

14. The device of claim 13, further comprising a cover attached to the main body, wherein the sliding drawer slides in and out of the cover.

15. The device of claim 14, wherein the mobile device is inserted into the main body when the cover is detached from the main body.

16. The device of claim 13, wherein the sliding drawer further comprises a tray.

17. The device of claim 16, wherein the tray has a recess.

18. The device of claim 17, wherein the recess has a height between 1 mm and 2 mm.

19. The device of claim 13, wherein the sliding drawer further comprises a front face connected to a tray and a finger recess is defined on the front face.

20. The device of claim 13, wherein the sliding drawer has a through-hole.
